(19) United States
(12) Patent Application Publication
(10) Pub. No.: US 2006/0081093 A1
(43) Pub. Date: Apr. 20, 2006

(54) Outboard motor propeller immobilizer tool

(75) Inventor: Patrick J. Grimes, Largo, FL (US)

Correspondence Address: LARSON AND LARSON, 11199 69TH STREET NORTH, LARGO, FL, 33773, US

(73) Assignee: PROP-MATE, INC.

(21) Appl. No.: 10/965,371

(22) Filed: Oct. 14, 2004

(51) Int. Cl. B25B 13/00; B25B 13/48

(52) U.S. Cl. 81/124.2; 81/176.1

(57) ABSTRACT

A handle is integral with a flange at one end. The flange is integral with a downwardly depending skirt having three slots for engagement with three corresponding radial struts in a propeller hub. A bore in the center of the flange permits entry of a socket portion of a wrench to engage a nut holding the propeller on a shaft within the hub. By turning the wrench counterclockwise and holding the handle on the immobilizer tool, the nut is removed from the shaft.

### BACKGROUND OF THE INVENTION

The present invention relates to a device to assist in the removal of an outboard engine propeller. More specifically, it refers to an integral extended handle and flanged portion with a depending slotted skirt for insertion into a propeller hub to prevent movement of the propeller during removal of a retaining nut.

In the prior art as set forth in U.S. Pat. No. 5,263,389 a wooden block is inserted between the propeller blades and lower portion of the outboard engine to prevent movement of the propeller blades while using a socket wrench with a hex profile keyed to the retaining nut for the propeller. Although this method achieves its intended purpose by immobilizing the propeller blades while the retaining nut is being removed, it causes pressure on the propeller blades which in some instances can cause damage to one of the propeller blades. A method of removing propellers from an outboard engine is needed which does not require pressure on the propeller blades.

### SUMMARY OF THE INVENTION

The present invention solves the problem of damaged propeller blades by providing a tool that immobilizes the propeller blades without even touching the blades. The tool has an extended handle integral at one end with a flange having a central bore for receiving a socket wrench. A downwardly depending skirt integral with a bottom surface of the flange, contains three vertical slots, each slot fitting over a radial strut within the hub of the propeller housing. By fitting the slots over the radial struts, the propeller cannot move. The bore in the tool is sufficiently wide to permit insertion of a socket wrench to remove the retaining nut on the propeller shaft.

### BRIEF DESCRIPTION OF THE DRAWINGS

This invention can be best understood by those having ordinary skill in the art by reference to the following detailed description, when considered in conjunction with the accompanying drawings in which:

FIG. 1 is a perspective view of a prior art method of removing a retaining nut from a propeller shaft.

FIG. 2 is a perspective view of the propeller immobilizer tool of this invention.

FIG. 3 is a rear end perspective view of a propeller hub and the immobilizer tool about to engage the hub struts.

FIG. 4 is a rear end perspective view of the immobilizer tool engaged to the hub struts with a wrench in a hole in the tool.

FIG. 5 is a partial cross-sectional view of the immobilizer tool engaged with the propeller hub struts.

### DETAILED DESCRIPTION OF THE INVENTION

Throughout the following detailed description, the same reference numerals refer to the same elements in all figures.

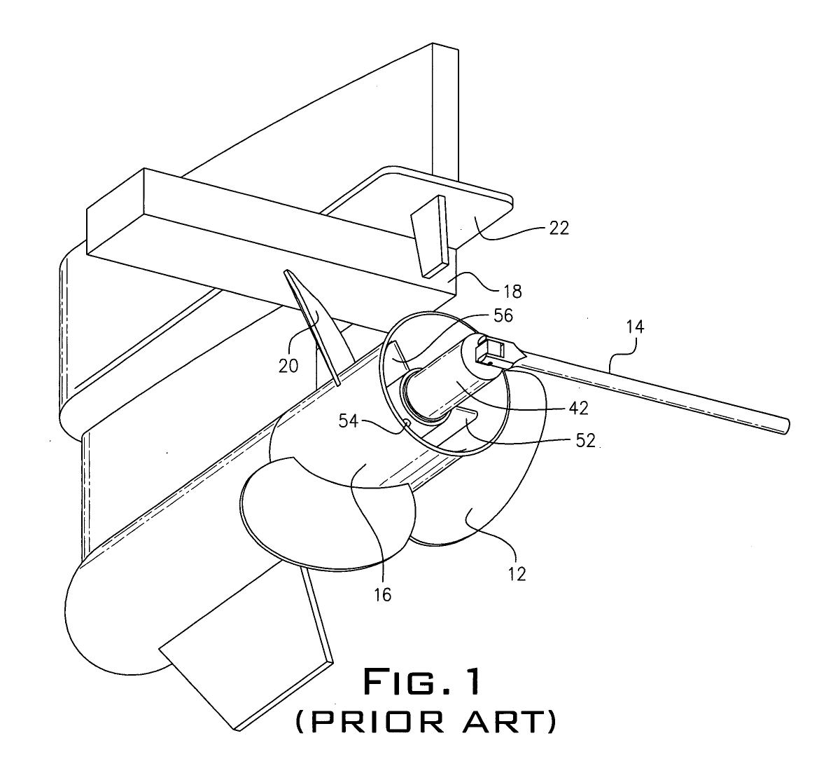

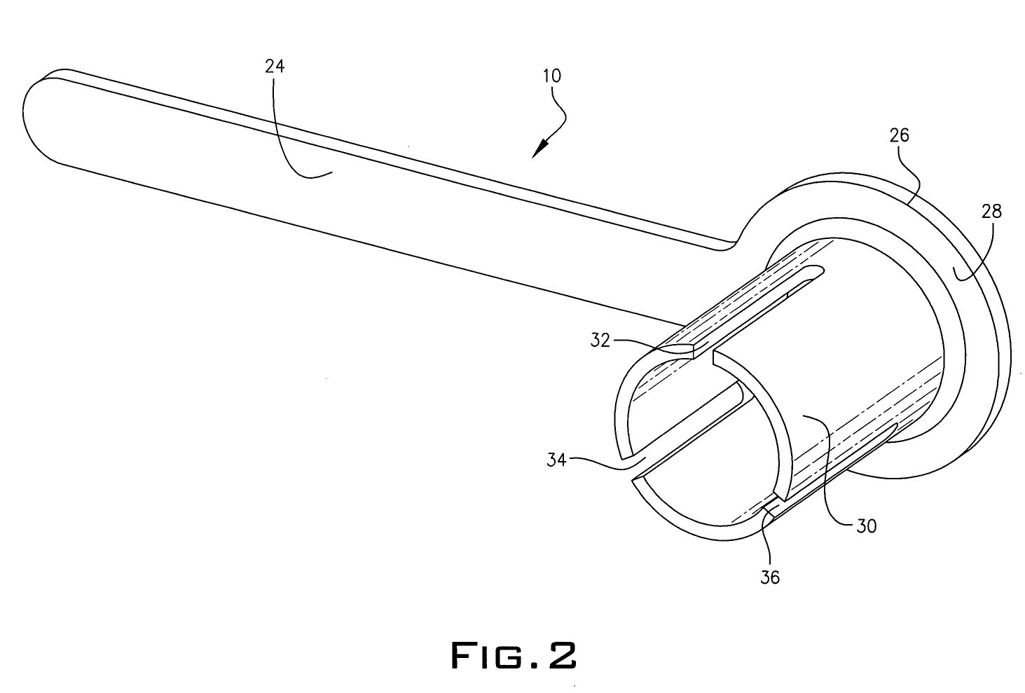

Referring first to FIG. 1, the prior art method of removing a propeller 12 from its shaft 60 is shown. A socket wrench 14 engages a nut 58 within the hub 16 of the propeller 12. To prevent the propeller 12 from turning as the wrench 14 is turned, a block of wood 18 is wedged between a propeller blade 20 and a splash plate 22 of an outboard motor housing. This cumbersome procedure causing possible damage to blade 20 is obviated by the immobilizer tool 10 shown in FIG. 2.

The immobilizer tool 10 has an elongated handle 24 integral with a flange 26. Integral with an undersurface 28 of the flange 26 is a downwardly depending skirt 30. The skirt has three slots 32, 34 and 36. The elongated handle 24 can be flat as shown in FIG. 2 or round. Other shapes customary for tool handles also can be substituted. The tool 10 is made of high strength aluminum, steel or a high strength polymer.

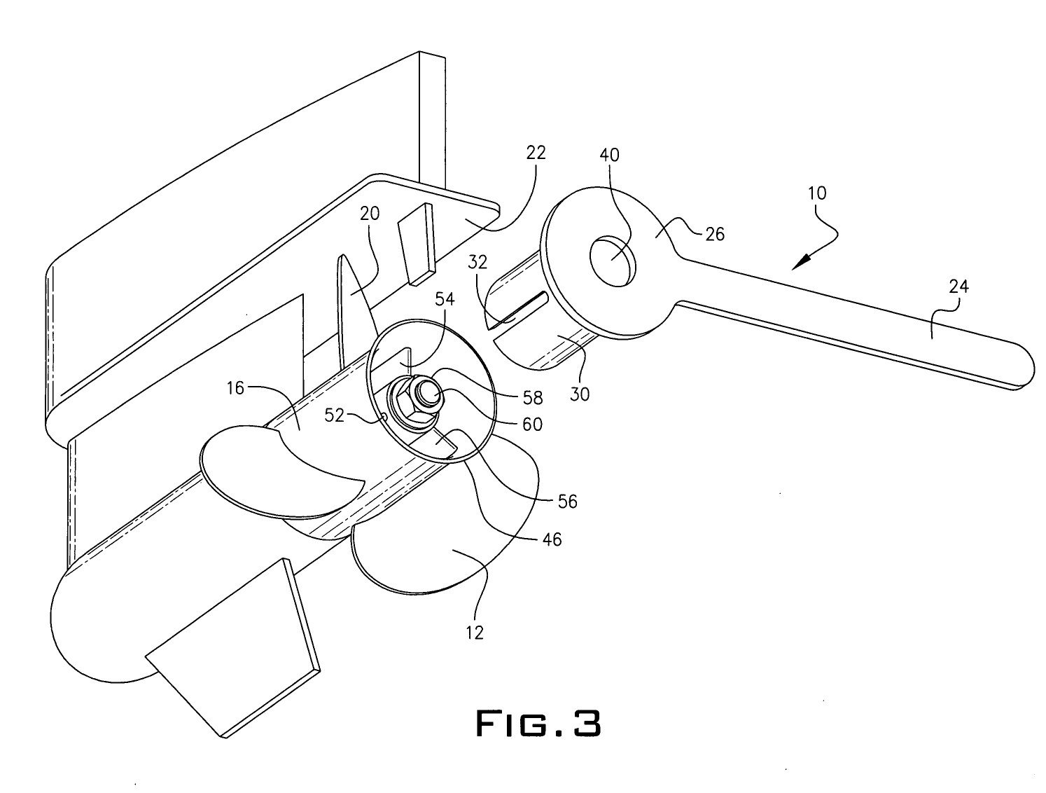

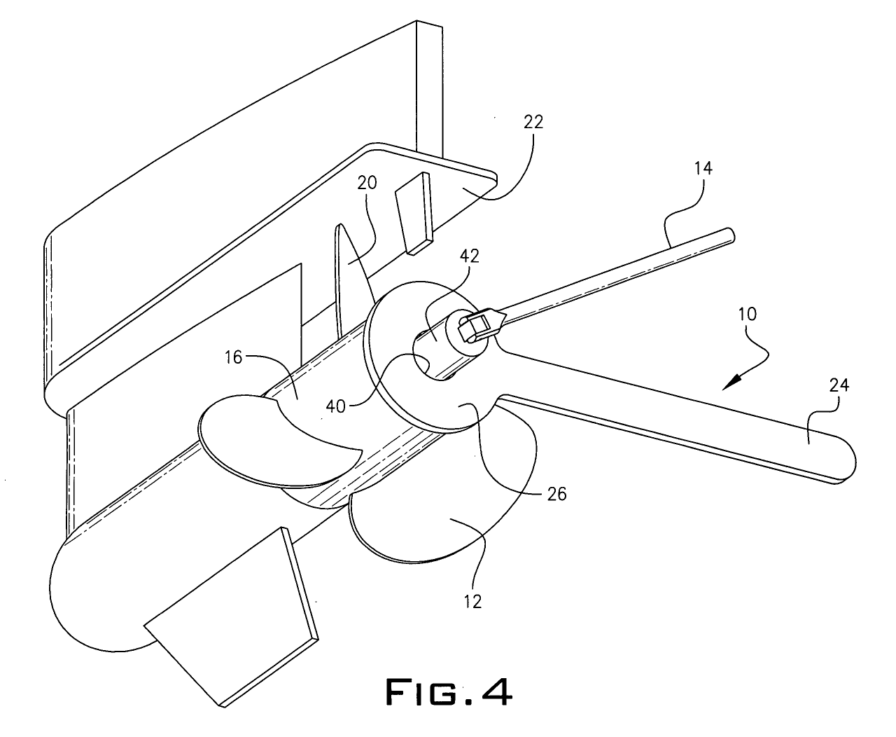

As seen in FIG. 3 the immobilizer tool 10 has a central bore 40 shown as an annular hole. The bore 40 must be sufficiently wide in diameter to accommodate a socket 42 of a socket wrench 14. The flange 26 must be sufficiently wide in diameter to overlap edge 46 on hub 16 as shown in FIG. 4.

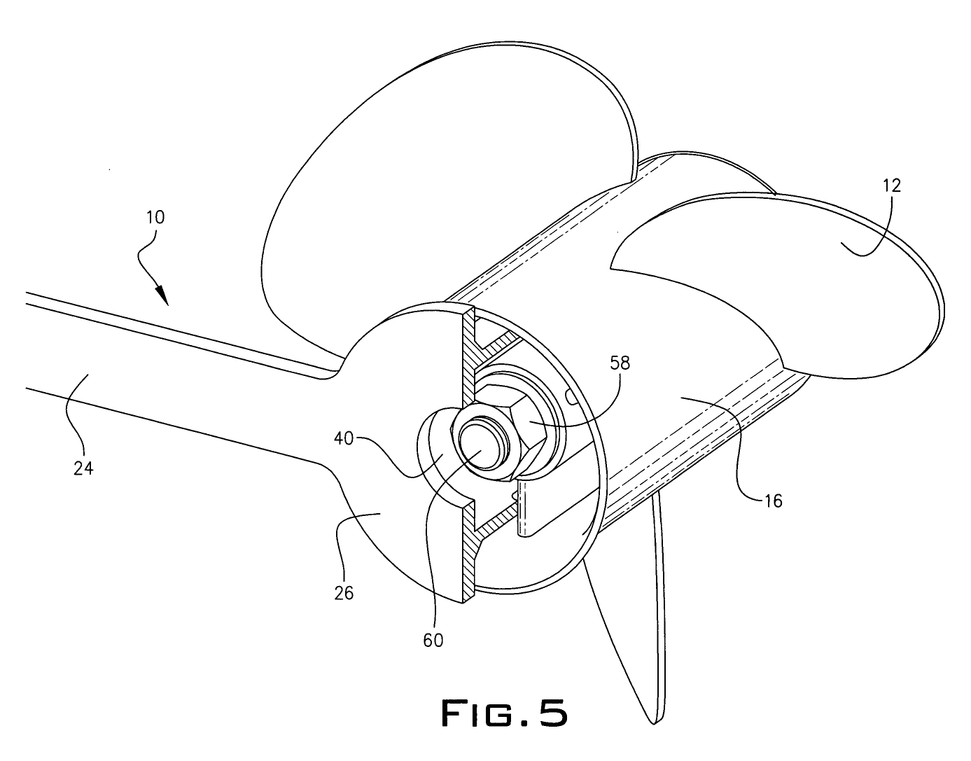

The immobilizer tool 10 is inserted into hub 16 so that slots 32, 34 and 36 slide over radial struts 52, 54 and 56. The underside 28 of the flange 26 rests on edge 46 of the hub 16 when fully inserted as shown in FIG. 4. Thereafter a socket portion 42 of a wrench 14 is inserted through bore 40 to engage nut 58 as shown in FIG. 5. The wrench 14 is turned counterclockwise while the handle 24 is held to loosen and remove nut 58 from the propeller shaft 60. After the nut 58 is removed the wrench 14 and immobilizer tool 10 are withdrawn and the propeller 12 is removed from its shaft 60.

Equivalent features of the immobilizer tool can be substituted to achieve the same results in the same way.

Having thus disclosed the invention, what is claimed and desired to be secured by Letters Patent follows:

1. A propeller immobilizer tool comprising:
(a) an extended handle integral with a flange, the flange having a central bore for receipt of a wrench component;
(b) a skirt integral with a bottom surface of the flange, the skirt downwardly depending from the flange; and
(c) three spaced apart vertical slots in the skirt.

2. The propeller immobilizer tool according to claim 1 wherein at least three spaced apart vertical slots respectively engage three radial struts in a hub of the propeller.

3. The propeller immobilizer tool according to claim 1 wherein the flange is at one end of the handle.

4. The propeller immobilizer tool according to claim 1 wherein the central bore is annular in shape.

5. The propeller immobilizer tool according to claim 1 wherein the slots in the skirt begin at an end of the skirt distal from the flange and extend part ways up an outer wall of the skirt towards the flange.

6. The propeller immobilizer tool according to claim 1 wherein the wrench component received by the central bore is a socket having an end profile contiguous with a nut holding the propeller in place on a shaft.

7. The propeller immobilizer tool according to claim 2 wherein the flange has a diameter greater than an outer diameter of the hub.

8. A method for removing a propeller from an outboard engine shaft, the method comprising:
(a) providing a propeller immobilizer tool, the tool having an extended handle integral with a flange, the flange having a central bore, and a skirt depending downwardly from the flange, the skirt having three spaced apart vertical slots;
(b) inserting the skirt in a hub of the propeller, the hub having three radial struts;
(c) sliding the skirt downwardly in the hub so that the three slots slide over the three radial struts;
(d) inserting a socket portion of a wrench into the central bore and pushing the socket portion downwardly to engage a nut on a shaft of the propeller;
(e) turning the socket wrench counterclockwise while holding the handle of the immobilizer tool to remove the nut from the shaft, and (f) pulling the propeller outwardly to remove the propeller from the shaft.
